(19) United States
(12) Patent Application Publication
(10) Pub. No.: US 2015/0283844 A1
(43) Pub. Date: Oct. 8, 2015

(54) METHODS AND APPARATUS FOR MESSAGE PERSONALIZATION

(71) Applicant: AKQA, Inc., San Francisco, CA (US)

(72) Inventors: Stephen William Clements, San Francisco, CA (US); Eric Diem, San Francisco, CA (US); Christopher Joon Miller, San Francisco, CA (US); Mikko Juhani Törmälä, San Francisco, CA (US)

(21) Appl. No.: 14/243,267

(22) Filed: Apr. 2, 2014

(51) Int. Cl. B42D 15/02; G10L 21/14; G11B 20/10

(52) U.S. Cl. CPC B42D 15/022; G11B 20/10527; G10L 21/14; G11B 2020/10555

(57) ABSTRACT

According to some aspects, a method of personalizing a message to be provided to a recipient is provided. The method may comprise obtaining audio data corresponding to the message, obtaining characteristic data from the audio data, incorporating the characteristic data into a representation of an object to provide a message object, and providing at least one presentation of the message object.

### BACKGROUND

People frequently commemorate holidays, special occasions and/or milestone events by sending a message to one or more recipients. Frequently, this type of commemoration takes the form of a card such as a holiday card, birthday card, anniversary card, valentine, etc. Such cards, while perhaps accurately expressing the intended sentiment and demonstrating thoughtfulness, often lack a certain personalization and/or uniqueness. For example, cards to commemorate holidays or occasions are often purchased from a retail outlet such that the sender has little or no part in the creation of the card and the card is not unique to the sender. To address this shortcoming in conventional messages/cards, the inventors have developed techniques for personalizing a message.

### SUMMARY

Some embodiments include a method of personalizing a message intended to be provided to a recipient comprising obtaining audio data corresponding to the message, obtaining characteristic data from the audio data, incorporating the characteristic data into a representation of an object to provide a message object, and providing at least one presentation of the message object.

Some embodiments include a device comprising at least one processor configured to access audio data corresponding to the message, obtain characteristic data from the audio data, incorporate the characteristic data into a representation of an object to provide a message object, and provide at least one presentation of the message object.

Some embodiments include at least one computer readable storage medium storing instructions that, when executed by at least one processor, perform a method of personalizing a message intended to be provided to a recipient, the method comprising obtaining audio data corresponding to the message, obtaining characteristic data from the audio data, incorporating the characteristic data into a representation of an object to provide a message object, and providing at least one presentation of the message object.

### BRIEF DESCRIPTION OF DRAWINGS

The accompanying drawings are not intended to be drawn to scale. In the drawings, for purposes of clarity, not every component may be labeled in every drawing. In the drawings:

FIG. 1 is an example of a message snowflake incorporating aspects of an audio message, in accordance with some embodiments;

FIGS. 2A-2C show exemplary techniques by which the user may present the message snowflake to a recipient, in accordance with some embodiments;

FIG. 3 is a flow chart depicting a method of generating a personalized message comprising at least one object representation, in accordance with some embodiments;

FIG. 4 illustrates a system 400 on which a user may provide audio data from which a message object may be created, in accordance with some embodiments;

FIGS. 5A-5D illustrate exemplary message objects created from the envelope of an audio waveform;

FIG. 6 illustrates a further example of a representation of an audio message incorporated into an object representation, in accordance with some embodiments;

FIG. 7 illustrates another example of a representation of an audio message incorporated into an object representation, in according with some embodiments; and

FIG. 8 illustrates an implementation of a computer system that may be used to implement one or more of the message personalization techniques described herein, in according with some embodiments.

### DETAILED DESCRIPTION

Messages sent from one individual, group or organization to another are frequently personal in nature. Irrespective of the medium by which a message is communicated, it may be desired to add a personal aspect to the message to convey an expression of friendship or other sentiment to the recipient, or to create a message that is unique to the sender. Thus, people and/or organizations may want to share personalized messages during a holiday or to commemorate a special occasion or event. The inventors have developed methods and apparatus that permit a user to create and share a personalized message based on audio of, for example, the user speaking the message. According to some embodiments, one or more aspects, properties or characteristics of audio data (characteristic data) received from a user are incorporated into at least one representation of an object associated with the content of the message to create a message object. The message object may then be presented to a recipient as one or more message object presentations.

A representation of an object (also referred to as an object representation) may be any mathematical, geometrical, pictorial, graphic, electronic or any other representation of a desired object. The object may be an object that relates to, or is otherwise associated with, the content of the message and/or is expressive of the content or sentiment of the message in a manner desired or selected by a user. For example, if the message is a holiday greeting, the object may be related to or representative of the holiday such as a snowflake for the winter holiday season, an ornament for Christmas, a heart for Valentine's Day, etc. If the message relates to a particular occasion or event, the object may be related to, representative or symbolic of the occasion such as a heart or champagne flute for an anniversary, a candle, cake or number for a birthday, etc. While using an object that is reflective of the content or subject of the message may be desired in many circumstances, the object may in general be any object that a user desires or selects for use in connection with the personalized message, as the techniques described herein are not limited for use with any particular object, nor need the object reflect any particular relationship between the object and the message.

As discussed above, one or more aspects, properties or characteristics of audio data provided by the user, referred to herein as “characteristic data,” may be obtained from the audio data and incorporated into the object representation to form a message object representation, which may in turn be presented to the user for review and/or presented to one or more desired recipients. The inventors have appreciated that a user may want to provide the message object to a recipient in one or more different presentations. For example, the user may want to provide the message object electronically via an electronic card (e-card), incorporated into a conventional card and/or presented as a tangible item such as a message object fabricated via 3D printing techniques (e.g., using one or more additive fabrication techniques). Accordingly, a presentation of a message object (also referred to as a message object presentation) may be incorporated in a tangible object (e.g., a message object printed on a card), may itself be a tangible object (e.g., a message object produced by a 3D printer), may be presented electronically (e.g., a message object presented on an e-card, presented on a display that renders images, graphics, text, provided as an email attachment, etc.), or may be some combination of the above (e.g., the message object may be printed on a card and additionally produced by a 3D printer). Examples of various illustrative message object presentations are provided in further detail below.

Following below are more detailed descriptions of various concepts related to, and embodiments of, methods and apparatus for providing a personalized message. It should be appreciated that various aspects described herein may be implemented in any of numerous ways. Examples of specific implementations are provided herein for illustrative purposes only. In addition, the various aspects described in the embodiments below may be used alone or in any combination, and are not limited to the combinations explicitly described herein.

Various aspects of the inventor's contribution to the art can be understood in connection with the following non-limiting example, wherein the object is a snowflake into which a representation of a user's audio message may be incorporated to produce a message object. The message object may be presented to the recipient as an e-card, may be printed on a card and sent to the recipient and/or may be 3D printed into a three-dimensional object. According to some embodiments, a user may provide audio data (e.g., a recording) of a message to be incorporated into a representation of a snowflake (e.g., the user may speak the message into a microphone attached to or integrated with the user's computer). For example, the user may speak the holiday message, “Happy holidays and best wishes for the New Year!” A representation of the audio data created by the user may be incorporated into or used to create the snowflake representation.

According to some embodiments, the audio waveform is used to create the “arms” of the snowflake. In particular, the magnitude and/or envelope of the waveform containing the message may be extracted from the audio data and used to generate a snowflake having a geometry that reflects one or more aspects of the audio waveform.

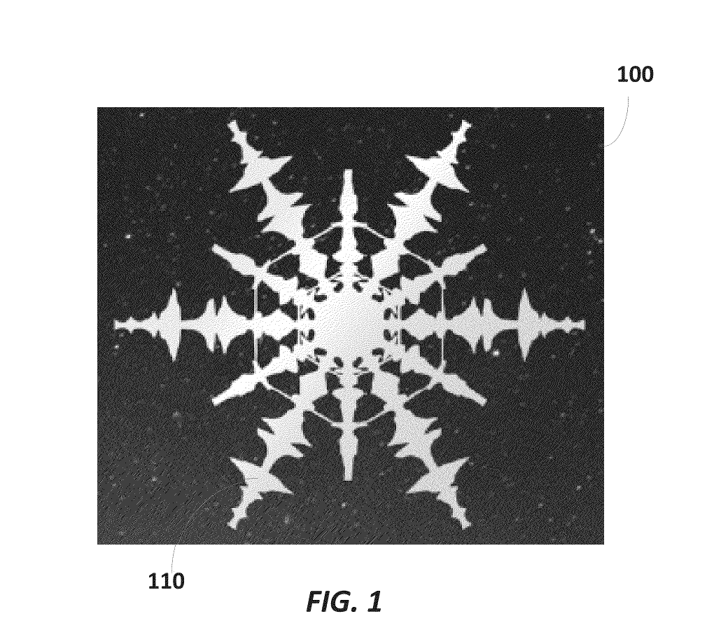

FIG. 1A illustrates an example of how the audio waveform may be utilized to create a snowflake representation that incorporates a representation of the message into the message snowflake. As illustrated by message snowflake 100, the magnitude of the audio waveform (e.g., the amplitude and/or envelope of the audio data) is used to form portion 110 of the snowflake. In particular, the envelope of the audio waveform (or some desired portion of the audio waveform) may be converted from magnitude as a function of time to magnitude as a function of space. The converted audio waveform may then be replicated a desired number of times and transformed appropriately to form the geometry of the message snowflake, or a portion of the snowflake geometry. As such, the user's message can essentially be incorporated into the representation of the snowflake to provide a unique personalized message object. The message snowflake may be presented to the user (e.g., displayed on the user's computer) so that the user can see the result and, if desired, may proceed with presenting the message snowflake to a recipient in one or more desired ways, examples of which are discussed in further detail below.

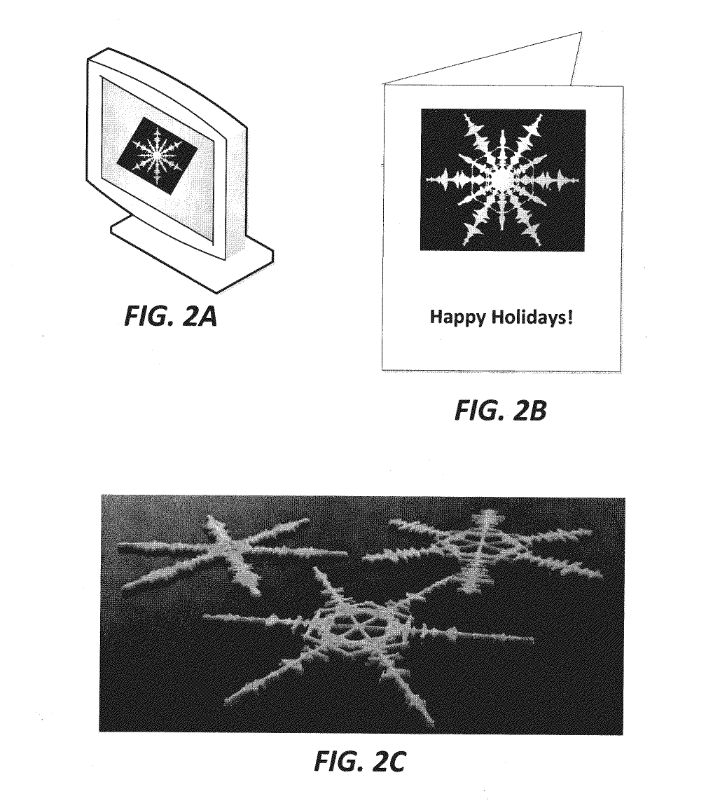

FIGS. 2A-2C show exemplary techniques by which the user may present the message snowflake to a recipient. In FIG. 2A, the message snowflake is presented electronically as an e-card. As illustrated schematically, the message snowflake may be displayed on a display of a recipient's computing device. For example, the recipient may view the e-card on a mobile device such as a smartphone, a personal computer such as a laptop or any other computing device capable of accessing a network over which the e-card may be provided (e.g., the Internet). The e-card may present the message snowflake along with the text of the message and/or any other content as may be appropriate or desired for an e-card. Additionally, the e-card may provide an interface (including, for examples, one or more buttons, links, menus, etc.) that allows the recipient to listen to the audio message incorporated into the message snowflake.

In FIG. 2B, the message snowflake is printed on a tangible card that may be delivered to the user or the recipient (e.g., via the postal service or other shipment service, courier delivery, etc., in real time via a kiosk or at a brick-and-mortar store, or provided by any other method). As with the e-card, the card may have the message printed on the card along with any other content that the user desires. To allow the recipient to listen to the audio message that is incorporated into the message snowflake, a uniform resource locator (URL), or any other identifier, may also be printed on or otherwise provided with the card that allows the user to access the audio message electronically using a network accessible computing device. According to some embodiments, the URL provides access to a corresponding e-card (e.g., as described in connection with FIG. 2A) that provides an interface that allows the audio message to be rendered. In addition, the tangible card may be a musical greeting card that plays sound, such as the audio message. For example, the card may include a speaker and suitable electronics that generate an audible representation of the audio message when the card is opened.

In FIG. 2C, the message snowflake is presented as a 3D printed snowflake, which may be delivered to the user or the recipient as discussed above in connection with the tangible card embodiment. The 3D printed message snowflake may also be accompanied by a URL that the recipient can utilize to access and listen to the audio message. For example, the 3D printed snowflake may be provided with or incorporated into a tangible card of the sort discussed above, or the URL may be printed on some other printable medium including the 3D printed message snowflake itself. It should be appreciated that the exemplary presentations described in connection with FIGS. 2A-2C may be used alone or in any combination, as the aspects are not limited in this respect.

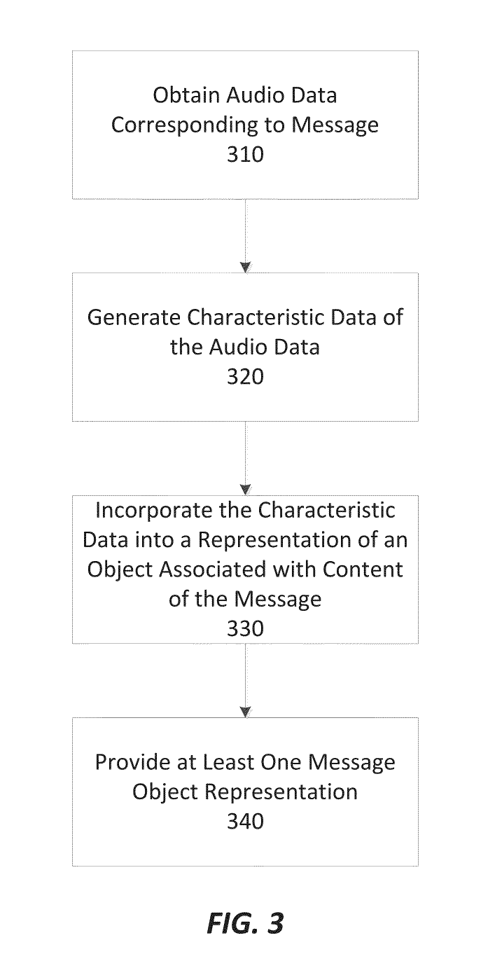

FIG. 3 is a flow chart depicting a method of generating a personalized message comprising at least one object representation, in accordance with some embodiments. In act 310, audio data corresponding to a message is received. The audio data may be a recording of a user speaking the message. For example, the user may record the holiday greeting, “Happy holidays and best wishes for the New Year!,” “Happy Valentine's Day, Love,” “Trick or Treat,” “Happy 40^{th} birthday, John,” or any other message that a user would like to convey to a recipient. The audio data may be provided in any suitable manner by which the message may be electronically encoded as an audio signal, as the techniques described herein are not limited to any particular manner of obtaining audio data. For example, a user may record the message using a microphone attached to or incorporated into the user's computing device (e.g., mobile phone, laptop, personal computer, etc.). Some non-limiting examples of obtaining audio data corresponding to the message are described in further detail below.

In act 320, characteristic data is/are generated from the audio data, for example, by obtaining one or more aspects, properties and/or characteristics from the audio data. The characteristic data may be associated with, related to and/or expressive of the content of the message. However, it is not in general a requirement that the object have any particular relationship with the content of the message. According to some embodiments, characteristic data representing the audio waveform may be extracted from the audio data (e.g., the envelope of the audio waveform may be obtained by extracting the magnitude or amplitude of the audio waveform or a portion thereof) to be incorporated within or otherwise used to form, at least in part, a representation of a message object. In this respect, the characteristic data may correspond to a visual representation of the audio data.

The characteristic data may be further processed and/or converted to a different format so that the data is suitable for incorporation into or used to form, for example, at least a portion of the geometry of the representation of the message object. It should be appreciated that the envelope of the waveform is merely one example of characteristic data that may be extracted from the audio data to use in providing a message object. For example, characteristic data may additionally, or alternatively, be generated using other audio parameters such as pitch, prosodic information and/or frequency information. Such parameters may be used alone or in any combination and/or may be used along with envelope information to guide or inform how the audio data is presented and incorporated into the object representation to form the message object.

In act 330, the characteristic data is incorporated into or otherwise used to form at least part of the representation of the object to provide a message object. As discussed above, where the characteristic data includes an envelope or a portion of an envelope of an audio waveform, the characteristic data may be used to form at least a portion of the representation of the message object. According to some embodiments, the characteristic data may form one or more portions and/or aspects of the message object representation (e.g., as shown in FIGS. 1 and 2A-2C). According to some embodiments, the data may be incorporated as a design on the object representation, may form a cut-out portion of the object representation, may form at least a portion of the geometry of the message object, and/or may be used in other ways to incorporate the data into the object representation or to otherwise factor into the representation of the message object.

As discussed above, the object may be anything associated with, related to, reflective of, or expressive of the content of the message and/or of the holiday, occasion or event for which the message is being provided. Alternatively, the object may have no particular relation to the message or the holiday/occasion, but is merely an object selected by the user. How the characteristic data is incorporated into the object representation therefore may depend on the type of object, the message content and/or the holiday or occasion for the message. According to some embodiments, the user may select the manner in which the characteristic data is incorporated into the object representation. The characteristic data incorporated into the object representation produces a message object.

In act 340, the message object is provided to the user and/or a recipient according to at least one message object presentation. As discussed above, a message object may be presented electronically (e.g., via a website or as an e-card), affixed to a tangible object (e.g., printed on a tangible card) and/or presented as a tangible object (e.g., 3D printed as a tangible 3D object). According to some embodiments, a user may select the one or more presentations by which the message object is provided. It should be appreciated that the above described method for providing a message object may be implemented in numerous ways, some examples of which are discussed in further detail below.

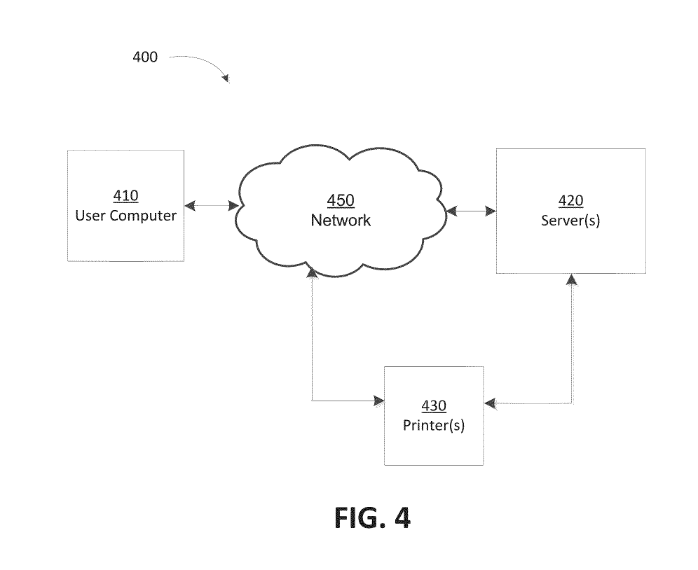

FIG. 4 illustrates a system 400 on which a user may provide audio data from which a message object may be created, in accordance with some embodiments. System 400 comprises a user computer 410 capable of connecting to a network to access a service configured to receive audio data and create a message object based on the received audio data from the user. For example, user computer 410 may access a website provided by one or more servers 420 over network 450 and render the content to the user via a browser on the user computer 410. Network 450 may comprise one or more networks including one or any combination of a wide area network (WAN) such as the Internet, one or more local area networks (LANs), one or more private networks and/or one or more other types of suitable networks providing device connectivity. User computer 410 may access network 450 via any number of connections utilizing wireless and/or wired connection techniques.

Using system 400, a user may access the online service to create a message object via user computer 410, for example, via a mobile device such as a smartphone or laptop computer, a personal computer, a terminal computer or other publically available computer (e.g., a kiosk), etc. The online service may provide content to be rendered on user computer 410 that allows the user to select an object and to provide audio data to incorporate into a representation of the object to create a message object. For example, the online service may allow the user to browse objects, search for objects, browse objects available for given holidays, events and/or occasions, etc. The online service may also provide an interface that allows the user to record a message which is then received by the online service. For example, the online service may provide a microphone icon that, when activated, allows a user to record a message or greeting which may be streamed or otherwise transmitted over network 450 and received by the online service (e.g., at one or more servers 420). Alternatively, the user may upload a previously recorded audio file which is provided via network 450 to the one or more servers providing the online service. Audio data may be provided in other ways, as the techniques described herein may be applied to any audio data received from a user, however provided.

Servers 420 may receive the audio data from the user and extract desired characteristic data (i.e., one or more aspects, characteristics and/or properties of the audio data) and, if needed, process and/or transform the characteristic data to a suitable form and format to incorporate the generated characteristic data into a representation of an object (e.g., the object selected by the user) to provide a message object representation. The manner in which the characteristic data is incorporated into the object representation may depend on the object for which a message object is being created as well as the aspects of the audio data being incorporated. As discussed above, some embodiments utilize the audio waveform to form at least part of the geometry of the message object representation. The resulting message object representation may then be presented electronically (e.g., may be provided in a data format describing the object representation, such as an image file, a 3D model, and/or a file containing instructions for a 3D printer) and/or may be printed using one or more printers 430. For example, printer(s) 430 may include one or more conventional printers for printing on, for example, paper media. Printer(s) 430 may also include one or more 3D printers for printing 3D objects, examples of which are described in further detail below.

It should be appreciated that system 400 is only one of many system configurations on which the above described online service for creating a message object may be implemented. The online service may be provided by a single server computer or may distributed over multiple computers connected via network 450. In some embodiments, a service for creating and presenting a message object may be implemented on an in-store kiosk or a computer station configured to allow a user to create and present a message object at a given location and immediately obtain one or more message object presentations, for example, message objects conventionally printed on paper media or 3D printed to obtain a 3D message object presentation.

As discussed above, message objects may be presented as a 3D printed object. Additive fabrication, often known as 3-dimensional (3D) printing, provides techniques for fabricating objects, typically by causing portions of a building material to solidify at specific locations. Additive fabrication techniques may include stereolithography, selective or fused deposition modeling, direct composite manufacturing, laminated object manufacturing, selective phase area deposition, multi-phase jet solidification, ballistic particle manufacturing, particle deposition, laser sintering or combinations thereof. Many additive fabrication techniques build parts by forming successive layers, which are typically cross-sections of the desired object. Typically each layer is formed such that it adheres to either a previously formed layer or a substrate upon which the object is built.

Any suitable additive fabrication technique, or techniques, may be utilized in producing a message object presentation. Message objects may be represented in a 3D printing context in any suitable way, including by producing a file from which a 3D printer may print a presentation of the message object, and/or by using a 3D printer to generate the presentation of the message object. For example, a message object representation may include a 3D model file (e.g., a Stereolithographic (STL) file, a Solidworks file, etc.) which a 3D printer can use to generate printing instructions. Alternatively, or additionally, a message object representation may include instructions for a 3D printer (e.g., G-Code). Furthermore, as discussed above, a message object presentation may itself be a 3D printed object.

As discussed above, characteristic data representing an audio waveform may be extracted from audio data, and may be incorporated within or otherwise used to form, at least in part, a representation of a message object. The characteristic data may be used to create a 3D model from which instructions for a 3D printer may be generated. For example, the shape of an audio waveform may be generated from audio data and used to form the shape of a surface in 3-dimensional space (e.g., by using the shape as an edge of a surface and/or as a cross-section through the surface). The shape may be used any number of times in constructing one or more surfaces such that a 3D object is produced that, at least in part, includes or was otherwise generated from the shape of the audio waveform.

It will be appreciated that where 3D printing (e.g., additive fabrication) is referred to herein, a computer-controlled cutting machine (e.g., a CNC router and/or CNC milling machine) could equally be used. For example, a message object representation may include instructions for a computer-controlled cutting machine or may otherwise include data from which a computer-controlled cutting machine can form an object. Other methods for creating a 3D object from a geometrical representation of an object may also be suitable, as producing a 3D message object is not limited for use with any particular technique, process or machine.

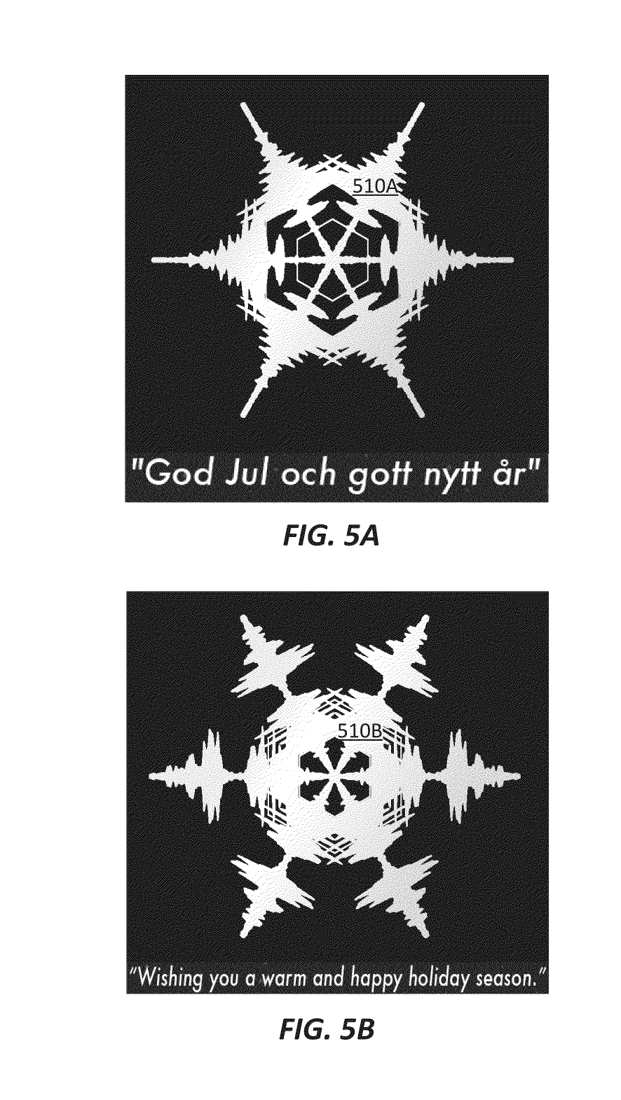

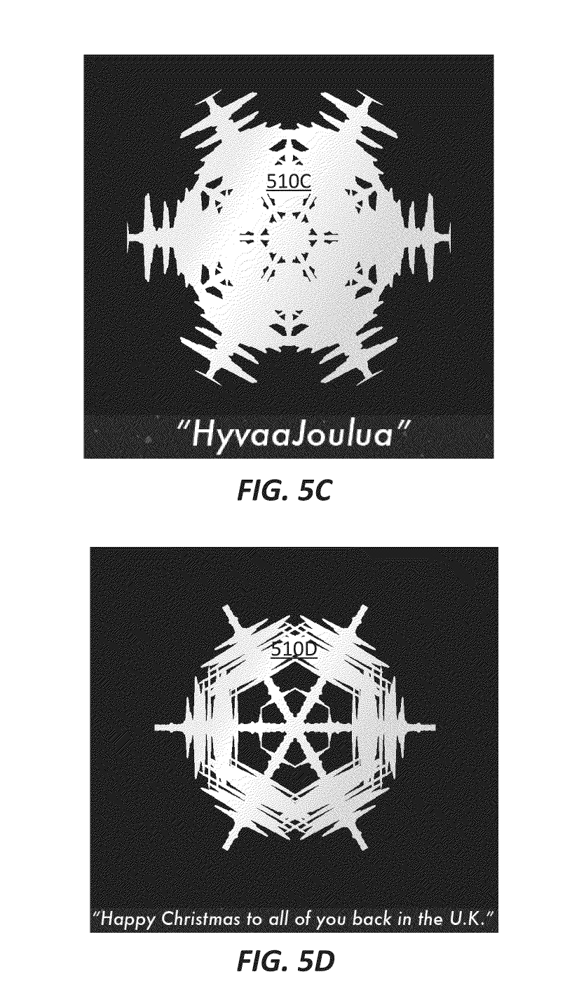

FIGS. 5A-5D illustrate exemplary message object representations created from the envelope of an audio waveform obtained from audio data of a user, wherein the objects are snowflakes having “arms” whose geometry is formed from the audio waveform envelope. The content of the message that created the respective message snowflake is provided in quotes below the corresponding message snowflake representation for purposes of illustration. The example message snowflakes may be presented to the user and/or recipient according to any one or combination of presentations including, but not limited to, one or more electronic presentations, one or more printed presentations (e.g., conventional printing or 3D printing), etc.

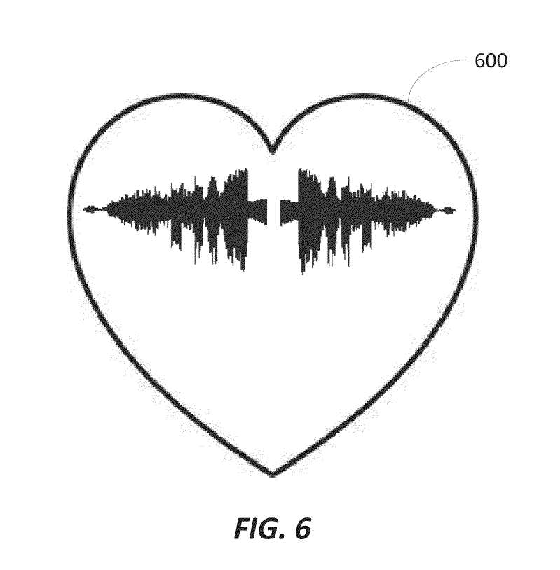

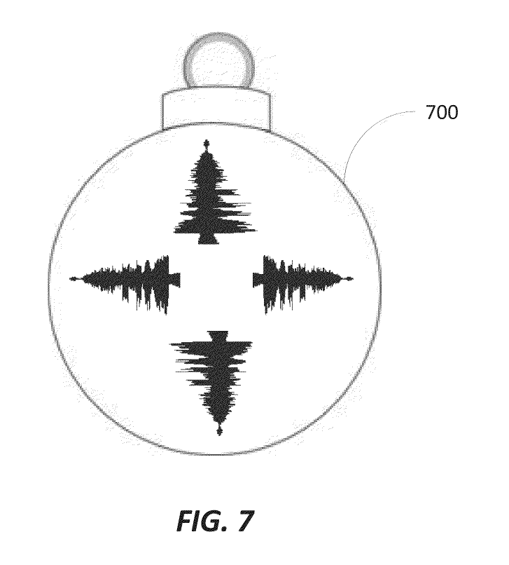

FIG. 6 illustrates another example of a representation of an audio message incorporated into an object representation to form a message object representation. In FIG. 6, the object corresponds to a heart and a representation of the audio waveform is incorporated thereon. Message heart 600 may be created, for example, as a valentine on Valentine's day. It should be appreciated that the heart representation is schematic for purposes of illustration but may be of any design, color and may include any other decorative or ornamental subject matter as desired. The message heart may be included in a printed valentine or may be provided electronically. For 3D printed presentations, the audio waveform may be printed in color on the 3D printed heart or the geometry of the waveform may be provided as a cut-out in the heart. That is, in the resulting 3D printed heart, the waveform may correspond to space within the material used for 3D printing. It should be appreciated that the audio data may be incorporated into the heart object in any other manner (e.g., characteristic data from the audio may form the outline of the heart or form any other part of the geometry of the heart), as incorporating characteristic data from audio data is not limited to any particular technique or techniques.

FIG. 7 illustrates another example of a representation of an audio message incorporated into an object representation. In the example of FIG. 7, the object corresponds to a ornament and a representation of the audio waveform is incorporated thereon. The message ornament 700 may be created, for example, as an ornament for the holiday season. It should be appreciated that the ornament representation is schematic for purposes of illustration but may be of any design, color and may include any other decorative or ornamental subject matter as desired. The message ornament may be included in a printed holiday card or may be provided electronically. For 3D printed presentations, the audio waveform may be printed in color on the 3D printed ornament or the geometry of the waveform may be provided as a cut-out in the ornament. That is, in the resulting 3D printed ornament, the waveform may correspond to space within the material used for 3D printing. The 3D printed message ornament may then be used as an actual ornament, for example, to be hung on a tree. It should be appreciated that the audio data may be incorporated into the ornament in any other manner (e.g., characteristic data from the audio may form the outline of the heart or form any other part of the geometry of the heart), as incorporating characteristic data from audio data is not limited to any particular technique or techniques.

It should be appreciated that techniques described herein may be utilize to create a message object of any type and for any occasion to provide a personalized message or memento for the occasion.

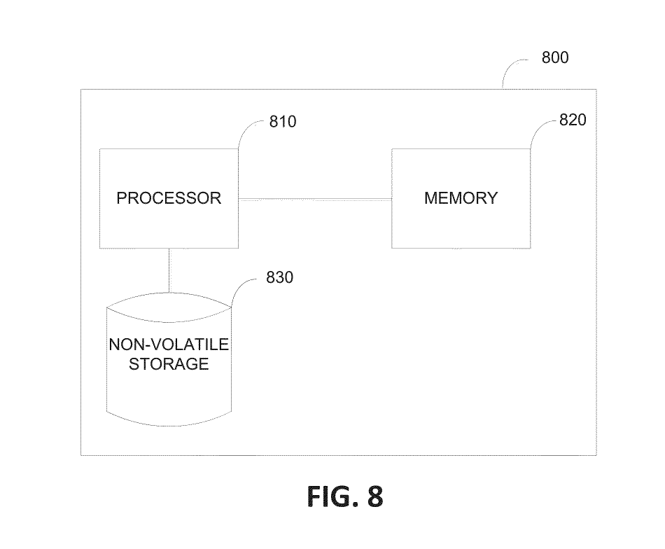

An illustrative implementation of a computer system 800 that may be used to implement one or more of the message personalization techniques described herein is shown in FIG. 8. The computer system 800 may include one or more processors 810 and one or more non-transitory computer-readable storage media (e.g., memory 820 and one or more non-volatile storage media 830). The processor 810 may control writing data to and reading data from the memory 820 and the non-volatile storage device 830 in any suitable manner, as the aspects of the invention described herein are not limited in this respect. To perform functionality and/or techniques described herein, the processor 810 may execute one or more instructions stored in one or more computer-readable storage media (e.g., the memory 820, storage media, etc.), which may serve as non-transitory computer-readable storage media storing instructions for execution by the processor 810.

In connection with message personalization techniques described herein, code used to generate one or more message objects may be stored on one or more computer-readable storage media of computer system 800. In addition, code capable of providing one or more message object presentations may also be stored on computer system 800. Processor 810 may execute any such code to provide any message personalization techniques described herein. Any other software, programs or instructions described herein may also be stored and executed by computer system 800. It will be appreciated that computer code may be applied to any aspects of methods and techniques described herein. For example, computer code may be applied to audio data, thereby producing a message object representation that includes instructions for a 3D printer as an output.

The various methods or processes outlined herein may be coded as software that is executable on one or more processors that employ any one of a variety of operating systems or platforms. Additionally, such software may be written using any of numerous suitable programming languages and/or programming or scripting tools, and also may be compiled as executable machine language code or intermediate code that is executed on a virtual machine or a suitable framework.

In this respect, various inventive concepts may be embodied as at least one non-transitory computer readable storage medium (e.g., a computer memory, one or more floppy discs, compact discs, optical discs, magnetic tapes, flash memories, circuit configurations in Field Programmable Gate Arrays or other semiconductor devices, etc.) encoded with one or more programs that, when executed on one or more computers or other processors, implement the various embodiments of the present invention. The non-transitory computer-readable medium or media may be transportable, such that the program or programs stored thereon may be loaded onto any computer resource to implement various aspects of the present invention as discussed above.

The terms “program,” “software,” and/or “application” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion among different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in non-transitory computer-readable storage media in any suitable form. Data structures may have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Also, various inventive concepts may be embodied as one or more methods, of which examples have been provided. The acts performed as part of a method may be ordered in any suitable way. Accordingly, embodiments may be constructed in which acts are performed in an order different than illustrated, which may include performing some acts simultaneously, even though shown as sequential acts in illustrative embodiments.

The indefinite articles “a” and “an,” as used herein in the specification and in the claims, unless clearly indicated to the contrary, should be understood to mean “at least one.” As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1. A method of personalizing a message comprising:
obtaining audio data corresponding to the message;
obtaining characteristic data from the audio data;
incorporating the characteristic data into a representation of an object to provide a message object; and
providing a representation of the message object configured to facilitate generating at least one presentation of the message object.

2. The method of claim 1, wherein the at least one presentation of the message object comprises a tangible object.

3. The method of claim 2, wherein the tangible object is provided using one or more printing techniques.

4. The method of claim 3, wherein the tangible object is fabricated using one or more additive fabrication techniques.

5. The method of claim 1, wherein the at least one presentation of the message object comprises an electronic presentation of the message object.

6. The method of claim 1, wherein the audio data comprises digitized audio of a user speaking the message, wherein the content of the message includes a message for a holiday or occasion and the object is representative of the holiday or occasion.

7. The method of claim 1, wherein incorporating the characteristic data into the object comprises forming at least a portion of the geometry of the message object using the characteristic data.

8. The method of claim 7, wherein the object includes a snowflake and wherein at least a portion of the geometry of a message snowflake formed from the characteristic data corresponds to a portion of the envelope of a waveform of the audio data.

9. The method of claim 1, further comprising providing in connection with the message object at least one locator that allows a recipient to access the audio data.

10. A device comprising:
at least one processor configured to:
access audio data corresponding to the message;
obtain characteristic data from the audio data;
incorporate the characteristic data into a representation of an object to provide a message object; and
provide a representation of the message object configured to facilitate generating at least one presentation of the message object.

11. The device of claim 10, wherein the at least one representation of the message object comprises data describing a three-dimensional object.

12. The device of claim 11, wherein the data describing a three-dimensional object comprises data for a 3D printer.

13. The device of claim 10, wherein the object is associated with a holiday or occasion, and wherein incorporating the characteristic data into the representation of the object comprises forming at least a portion of the geometry of the message object using the characteristic data.

14. At least one computer readable storage medium storing instructions that, when executed by at least one processor, perform a method of personalizing a message comprising:
obtaining audio data corresponding to the message;
obtaining characteristic data from the audio data;
incorporating the characteristic data into a representation of an object to provide a message object; and
providing a representation of the message object configured to facilitate generating at least one presentation of the message object.

15. The at least one computer readable storage medium of claim 14, wherein the at least one presentation of the message object comprises a tangible object.

16. The at least one computer readable storage medium of claim 15, wherein the tangible object is provided using one or more printing techniques.

17. The at least one computer readable storage medium of claim 16, wherein the tangible object is fabricated using one or more additive fabrication techniques and/or using one or more printing techniques on a paper medium.

18. The at least one computer readable storage medium of claim 14, wherein the at least one presentation of the message object comprises an electronic presentation of the message object.

19. The at least one computer readable storage medium of claim 14, wherein the audio data comprises digitized audio of a user speaking the message, wherein the content of the message includes a message for a holiday or occasion, and wherein the object is representative of the holiday or occasion.

20. The at least one computer readable storage medium of claim 14, wherein the object includes a snowflake, and wherein incorporating the characteristic data into the object comprises forming at least a portion of the geometry of the snowflake using the characteristic data.
